(19) United States
(12) Patent Application Publication
(10) Pub. No.: US 2025/0224351 A1
(43) Pub. Date: Jul. 10, 2025

(54) RADIATION DETECTION DEVICE AND RADIATION DETECTOR

(71) Applicant: HORIBA, LTD., Kyoto-shi, Kyoto (JP)

(72) Inventors: Daisuke MATSUNAGA, Kyoto-shi, Kyoto (JP); Hiroki MINOWA, Kyoto-shi, Kyoto (JP)

(21) Appl. No.: 18/851,523

(22) PCT Filed: Apr. 25, 2023
(86) PCT No.: PCT/JP2023/016267

§ 371 Date: Sep. 26, 2024

(30) Foreign Application Priority Data
Apr. 28, 2022 (JP) 2022-075250

(51) Int. Cl. G01N 23/223; G01T 1/24

(52) U.S. Cl. CPC G01N 23/223; G01T 1/24; G01N 2223/316

(57) ABSTRACT

A radiation detection device including an illumination unit illuminating a sample, an irradiation unit irradiating the sample with X-rays and a radiation detection element detecting X-rays generated from the sample is provided with a magnetic field production unit that produces a magnetic field in part of a space from the sample to the radiation detection element and a block that holds the magnetic field production unit. The block is located at a position where light from the illumination unit to the radiation detection element is shielded.

### TECHNICAL FIELD

The present invention relates to a radiation detection device and a radiation detector that are used for detecting fluorescent X-rays.

### BACKGROUND ART

The X-ray fluorescence analysis is a technique of irradiating a sample with X-rays, detecting fluorescent X-rays generated from the sample and analyzing the sample based on a spectrum of the fluorescent X-rays. A radiation detection element for detecting fluorescent X-rays is an element using a semiconductor, for example. From the sample irradiated with X-rays, photoelectrons other than fluorescent X-rays are generated. In the case where the photoelectrons enter the radiation detection element, the sensitivity to fluorescent X-rays deteriorates. This necessitates a countermeasure against the photoelectrons. Patent Literature 1 discloses a technique of preventing secondary electrons from entering a radiation detection element for detecting X-rays in an electron microscope.

### CITATION LIST

### Patent Literature

Patent Literature 1: Japanese Patent Application Laid-Open Publication No. 2019-33080

### SUMMARY OF INVENTION

### Technical Problems

In the X-ray fluorescence analysis, a sample is illuminated for observation. In the case where illumination light for illuminating a sample enters the radiation detection element, electric current occurs in a radiation detection element, which may cause a malfunction in a radiation detection device provided with the radiation detection element.

The present invention is made in light of such circumstances, and the object is to provide a radiation detection device and a radiation detector that suppress the entrance of photoelectrons and illumination light into the radiation detection element.

### Solution to Problems

A radiation detection device according to one aspect of the present invention including an illumination unit illuminating a sample, an irradiation unit irradiating the sample with X-rays and a radiation detection element detecting X-rays generated from the sample, is characterized by comprising: a magnetic field production unit that produces a magnetic field in part of a space from the sample to the radiation detection element; and a block that holds the magnetic field production unit. The block is located so as to shield light from the illumination unit to the radiation detection element.

In one aspect of the present invention, the radiation detection device for detecting fluorescent X-rays is provided with a magnetic field production unit that produces a magnetic field in part of a space from the sample to the radiation detection element. The travel direction of photoelectrons generated from the sample is bent by the magnetic field, which hinders the photoelectrons from entering the radiation detection element. Thus, entrance of photoelectrons into the radiation detection element is suppressed. In addition, the radiation detection device is provided with a block to hold the magnetic field production unit. The block shields the light from the illumination unit to the radiation detection element, which hinders the light from entering the radiation detection element. Thus, entrance of illumination light for illuminating a sample into the radiation detection element is suppressed.

In the radiation detection device according one aspect of the present invention, it is characterized in that the magnetic field production unit and the block are subjected to anti-reflective treatment.

In one aspect of the present invention, the block and the magnetic field production unit are subjected to anti-reflective treatment, and thus light is hard to be reflected by the block and the magnetic field production unit and reach the radiation detection element. Thus, entrance of light into the radiation detection element is more suppressed.

In the radiation detection device according one aspect of the present invention, it is characterized in that the magnetic field production unit includes a magnet, and the magnet is coated with a substance of an element with an atomic number smaller than an atomic number of an element contained in the magnet.

In one aspect of the present invention, the magnetic field production unit includes a magnet, and the magnet is coated with a substance of an element with an atomic number smaller than an element contained in the magnet. X-rays generated from the magnet due to the entrance of X-rays or the collision of photoelectrons are absorbed in the substance coating the magnet and are hard to enter the inside of the radiation detection element. The fluorescent X-rays generated from the substance coating the magnet have less energy and low intensity. Thus, the system peaks caused by the fluorescent X-rays generated from the magnets are reduced.

In the radiation detection device according one aspect of the present invention, it is characterized in that the magnetic field production unit includes a plurality of magnets opposing each other with part of a space from the sample to the radiation detection element interposed between the magnets, and an interval between the plurality of magnets varies in a direction from the sample to the radiation detection element, the interval being wider toward the radiation detection element.

In one aspect of the present invention, the magnetic field production unit includes a plurality of magnets opposing each other, while the interval between the plurality of magnets is widened from the sample toward the radiation detection element. The fluorescent X-rays generated from the sample is wider toward the radiation detection element. The interval between the plurality of magnets is wider toward the radiation detection element, which increases the probability of the fluorescent X-rays entering the radiation detection element without being directed onto the magnets, and thus increases the probability of the fluorescent X-rays being detected.

In the radiation detection device according one aspect of the present invention, it is characterized in that the block has an internal space, the magnetic field production unit is located inside the block, and the block is made of a ferromagnetic material.

In one aspect of the present invention, the magnetic field production unit is located inside the block, and the block is made of a ferromagnetic material. The magnetic field produced by the magnetic field production unit is shielded by the block. The magnetic field does not leak outside the block and thus does not adversely affect the outside of the block.

In the radiation detection device according one aspect of the present invention, it is characterized in that a straight path from the sample to the radiation detection element is not blocked.

In one aspect of the present invention, a straight path from the sample to the radiation detection element is not blocked by an object such as a window including a window material. The fluorescent X-rays thus enter the radiation detection element without passing through the window or the like and are detected. The radiation detection device can detect radiation that cannot pass through the window material due to its low energy.

The radiation detection device according one aspect of the present invention is characterized by further comprising: a spectrum production unit that produces a spectrum of radiation detected using the radiation detection element, and a display unit that displays the spectrum produced by the spectrum production unit.

In one aspect of the present invention, a spectrum of the fluorescent X-rays generated from the sample is produced, and the produced spectrum is displayed on the display unit. Thus, the user can check the spectrum of the fluorescent X-rays generated from the sample.

A radiation detector according one aspect of the present invention for detecting fluorescent X-rays is characterized by comprising: a block having an internal space: an incidence port formed on the block and through which the fluorescent X-rays enter; a radiation detection element facing the incidence port; and a magnetic field production unit that is located inside the block and produces a magnetic field in a space from the incidence port to the radiation detection element, and the incidence port is not closed, and a straight path from the incidence port to the radiation detection element is not blocked.

In one aspect of the present invention, a radiation detector for detecting fluorescent X-rays includes a block and a magnetic field production unit that produces a magnetic field in part of the space from the incidence port to the radiation detection element. The travel direction of photoelectrons entering from the incidence port into the radiation detector is bent by the magnetic field, which prevents the photoelectrons from entering the radiation detection element. The block shields the light from the outside of the radiation detector, which hinders light from entering the radiation detection element. Thus, entrance of illumination light for illuminating a sample into the radiation detection element is suppressed.

### Advantageous Effects of Invention

In the present invention, by suppressing photoelectrons and illumination light entering the radiation detection element, advantageous effects are produced such as prevention of the deterioration in the sensitivity to radiation and of the malfunction of the radiation detection device.

### BRIEF DESCRIPTION OF DRAWINGS

FIG. 1 is a block diagram illustrating an example of the functional configuration of a radiation detection device.

FIG. 2 is a schematic cross-sectional view illustrating an example of the internal configuration of a radiation detector.

FIG. 3 is a schematic cross-sectional view illustrating a radiation detection element and a collimator.

### DESCRIPTION OF EMBODIMENTS

The present invention will be described in detail below with reference to the drawings showing embodiment thereof.

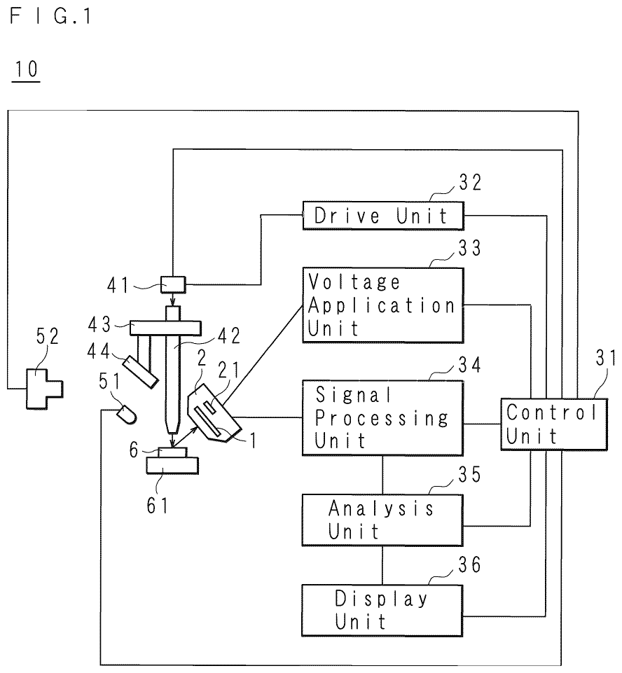

FIG. 1 is a block diagram illustrating an example of the functional configuration of a radiation detection device 10. The radiation detection device 10 is, for example, an X-ray fluorescence analysis device. A sample stage 61 on which a sample 6 is placed, an irradiation unit 41 that irradiates the sample 6 with X-rays, an X-ray optics 42 that converges X-rays, and a radiation detector 2 are provided. The sample 6 may be held by a method other than being placed on a stage. The irradiation unit 41 is, for example, an X-ray tube. The X-ray optics 42 is, for example, a mono-capillary lens using an X-ray guide tube that guides X-rays while reflecting incident X-rays at the internal surface, or a poly-capillary lens using multiple X-ray guide tubes. The irradiation unit 41 emits X-rays, and the X-ray optics 42 receives the X-rays emitted by the radiation unit 41, converges the X-rays, and irradiates the sample 6 placed on the sample stage 61 with the converged X-rays. The sample 6 irradiated with the X-rays generates fluorescent X-rays, and the radiation detector 2 detects the fluorescent X-rays generated from the sample 6. In the drawing, the X-rays and the fluorescent X-rays are indicated by the arrows. The radiation detection device 10 may hold the sample 6 by a method other than the method of placing the sample 6 on the sample stage 61.

The radiation detection device 10 is provided with an illumination unit 51 that illuminates the sample 6, a mirror 44, an imaging unit 52 and a switching stage 43 that switches the positions of the X-ray optics 42 and the mirror 44. The illumination unit 51 has a light source such as a light-emitting diode (LED) and is capable of turning the light source on and off. The light source is turned on to generate illumination light for illuminating the sample 6. The illumination unit 51 illuminates the sample 6 placed on the sample stage 61. The imaging unit 52 takes an image of the sample 6 illuminated by the illumination unit 51. The imaging unit 52 has, for example, an optical system and an image pickup device.

The switching stage 43 is provided with the X-ray optics 42 and the mirror 44, and can move to change the positions of the X-ray optics 42 and the mirror 44. The switching stage 43 is coupled with a drive unit 32 that moves the switching stage 43. The drive unit 32 is formed by a motor, for example. The operation of the drive unit 32 moves the switching stage 43 to thereby change the positions of the X-ray optics 42 and the mirror 44. The switching stage 43 can locate the X-ray optics 42 at the irradiation position as illustrated in FIG. 1. The irradiation position is the position where the X-ray optics 42 receives X-rays incident from the irradiation unit 41 and emits the X-rays to irradiate the sample 6 therewith.

The switching stage 43 can change the positions of the X-ray optics 42 and the mirror 44 to locate the mirror 44 in an image-taking position. The image-taking position is the position where the optical axis of the mirror 44 in the image-taking position and the optical axis of the X-ray optics 42 in the irradiation position are coaxial with each other. The mirror 44 in the image-taking position is located on the irradiation axis of the X-rays. The light from the illumination unit 51 is reflected at the sample 6. The mirror 44 in the image-taking position reflects the light from the sample 6 to make the light incident on the imaging unit 52. The imaging unit 52 takes an image of the sample 6 using the incident light.

The radiation detector 2 contains a radiation detection element 1 and a preamplifier 21. The preamplifier 21 may be located partially inside the radiation detector 2 and partially outside the radiation detector 2. The radiation detector 2 is connected to a signal processing unit 34 and a voltage application unit 33 that applies voltage required for radiation detection to the radiation detection element 1. The signal processing unit 34 is connected to an analysis unit 35. The analysis unit 35 is formed by a computer. The analysis unit 35 is connected to a display unit 36, such as a liquid crystal display and an EL (Electroluminescent) display.

The drive unit 32, the voltage application unit 33, the signal processing unit 34, the analysis unit 35, the display unit 36, the irradiation unit 41, the illumination unit 51 and the imaging unit 52 are connected to a control unit 31. The control unit 31 controls the operations of the drive unit 32, the voltage application unit 33, the signal processing unit 34, the analysis unit 35, the display unit 36, the irradiation unit 41, the illumination unit 51 and the imaging unit 52. The control unit 31 is formed by using a computer containing an arithmetic unit that performs arithmetic operation for controlling each unit. The control unit 31 may be configured to accept the operation by the user and control each unit of the radiation detection device 10 according to the accepted operation. The control unit 31 and the analysis unit 35 may integrally be formed with each other.

The control unit 31 controls the drive unit 32 to move the switching stage 43, which locates the mirror 44 in the image-taking position. The control unit 31 turns on the illumination unit 51 with the mirror 44 in the image-taking position. The sample 6 is illuminated by light from the illumination unit 51 and is imaged by the imaging unit 52. The imaging unit 52 generates a taken image of the sample 6 and transmits it to the control unit 31. The control unit 31 displays the taken image on the display unit 36. The user observes the sample 6 by viewing the taken image. The control unit 31 controls the drive unit 32 to move the switching stage 43 and locate the X-ray optics 42 in the irradiation position. The control unit 31 causes the irradiation unit 41 to generate X-rays with the X-ray optics 42 in the irradiation position. The X-rays emitted from the irradiation unit 41 passes through the X-rays optics 42 and is directed onto the sample 6.

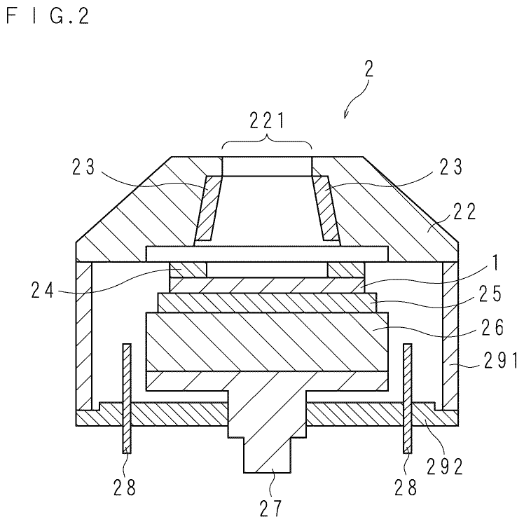

FIG. 2 is a schematic cross-sectional view illustrating an example of the internal configuration of the radiation detector 2. The radiation detector 2 is a Silicon Drift Detector (SDD). The radiation detector 2 is provided with a cylindrical part 291, a block 22 connected in such a manner as to cover one end of the cylindrical part 291, and a bottom plate part 292 shielding the other end of the cylindrical part 291. The block 22, the cylindrical part 291 and the bottom plate part 292 constitute a housing of the radiation detector 2. The other components of the radiation detector 2 are located inside the housing. The block 22 is made of a ferromagnetic material such as iron and is integrally formed. The block 22 has a shape of a truncated cone. At the tip of the block 22, an incidence port 221 is formed through which fluorescent X-rays to be detected by the radiation detector 2 enter. The incidence port 221 is an opening that connects the outer surface of the block 22 to the internal space of the block 22. The incidence port 221 is not closed while being provided with no windows including a window material. The block 22 is integrally formed. There is no clearance in communication with the internal space of the block 22 except for the incidence port 221.

The housing composed of the block 22, the cylindrical part 291 and the bottom plate part 292 contains the radiation detection element 1, a magnetic field production part 23, a collimator 24, a circuit board 25, a cooling part 26, a heat transfer part 27 and lead pins 28. The cooling part 26 is, for example, a Peltier device. The radiation detection element 1 is mounted on the surface of the circuit board 25 and is located at the position facing the incidence port 221. The collimator 24 has a cylindrical shape with open ends and is made of an X-ray shielding material. The collimator 24 is located between the radiation detection element 1 and the incidence port 221. One end of the collimator 24 faces the incidence port 221 while the other end thereof faces a surface of the radiation detection element 1. Fluorescent X-rays pass through the incidence port 221, enter the inside of the block 22 and are then partially shielded by the collimator 24. The radiation detection element 1 detects the incident fluorescent X-rays without being shielded by the collimator 24. The straight path of fluorescent X-rays from the incidence port 221 to the radiation detection element 1 is not blocked. The straight path of fluorescent X-rays from the sample 6 to the radiation detector 2 is also not blocked. Accordingly, the straight path of fluorescent X-rays from the sample 6 through the incidence port 221 to the radiation detection element 1 is not blocked by an object such as a window including a window material.

Between the incidence port 221 and the collimator 24, the magnetic field production part 23 is located. The magnetic field production part 23 is placed in the internal space of the block 22. The magnetic field production part 23 is attached to the block 22. The magnetic field production part 23 is attached to the block 22, so that the block 22 holds the magnetic field production part 23. The magnetic field production part 23 is configured so that multiple magnets are placed to face each other in the internal space of the block 22. The magnetic field production part 23 produces a magnetic field in part of the internal space of the block 22 by the magnets. The magnets employed for the magnetic field production part 23 may be permanent magnets or electromagnets. For example, the magnetic field production part 23 is attached to the block 22 by the magnets being magnetized or bonded to the block 22. The magnetic field production part 23 is placed so that an electric field is produced in at least part of the space from the incidence port 221 to the radiation detection element 1. Specifically, the magnets contained in the magnetic field production part 23 are placed on opposite sides of the space from the incidence port 221 to the radiation detection element 1. The magnetic field production part 23 produces a magnetic field in at least part of the space from the incidence port 221 to the radiation detection element 1. Accordingly, a magnetic field occurs in part of the space from the sample 6 to the radiation detection element 1.

The circuit board 25 is provided with a circuit and mounted with a preamplifier 21. FIG. 2 does not illustrate the preamplifier 21. The circuit formed on the circuit board 25 is connected to the outside of the radiation detector 2. Application of voltage to the radiation detection element 1 by the voltage application unit 33 and output of signals from the preamplifier 21 are carried out via the circuit.

The back surface of the circuit board 25 is in thermal contact with an endothermic portion of the cooling part 26, either directly or through an interposing element. A heat dissipation portion of the cooling part 26 is in thermal contact with the heat transfer part 27. The heat transfer part 27 has a flat-plate portion with which the heat dissipation portion of the cooling part 26 is in thermal contact and a portion that penetrates the bottom plate part 292. The heat of the radiation detection element 1 is absorbed in the cooling part 26 through the circuit board 25, transferred from the cooling part 26 to the heat transfer part 27, and released to the outside of the radiation detector 2 through the thermal transfer part 27. The radiation detection element 1 is thus cooled. The heat transfer part 27 may be coupled to a heat dissipation mechanism such as a heat sink located outside the radiation detector 2. The heat transfer part 27 may have a structure for heat dissipation such as a protrusion to be coupled to the heat dissipation mechanism. The heat transfer part 27 may be integrated with the bottom plate part 292. The radiation detector 2 does not necessarily have the heat transfer part 27, but the bottom plate part 292 may serve as the heat transfer part 27. The radiation detector 2 may additionally be provided with another component.

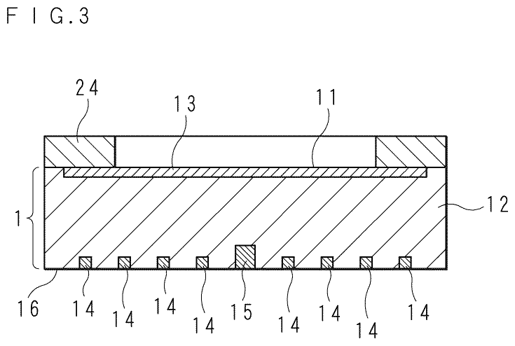

FIG. 3 is a schematic cross-sectional view illustrating the radiation detection element 1 and the collimator 24. The radiation detection element 1 is a silicon drift radiation detection element. The radiation detection element 1 is generally plate-shaped. For example, the radiation detection element 1 is circular in plan view. The radiation detection element 1 has a plate-shaped semiconductor portion 12 made of Si (silicon). The semiconductor portion 12 is made of N type Si. The radiation detection element 1 has an incident surface 11 on the light incident side where radiation to be detected enters and an electrode surface 16 on the back side of the incident surface 11. A part of the incident surface 11 is covered with the collimator 24. The radiation detection element 1 is placed so that the electrode surface 16 faces the circuit board 25 while the incident surface 11 faces the incidence port 221.

At a part of the incident surface 11 side of the semiconductor portion 12, an electrode layer 13 is provided. The electrode layer 13 is doped with a dopant that allows Si to have a different type from that of the component of the semiconductor portion 12. The electrode layer 13 is made of P type Si doped with a specific dopant such as boron and is made of, for example, p+Si. The electrode layer 13 is formed on the most of the area along the incident surface 11 including the portion corresponding to the center of the incident surface 11 in plan view. For example, the electrode layer 13 is circular in plan view. The electrode layer 13 is formed on the whole area corresponding to the portion not covered by the collimator 24 throughout the incident surface 11. There is an area where the electrode layer 13 is not formed at the peripheral of the incident surface 11.

At a part of the electrode surface 16 of the semiconductor portion 12, a signal output electrode 15, which is an electrode for outputting a signal when detecting radiation, is provided. The signal output electrode 15 is made of Si of the same type as that of the semiconductor portion 12. For example, the signal output electrode 15 is made of n+Si doped with a specific dopant such as phosphorus. At parts of the electrode surface 16 of the semiconductor portion 12, multiple curved electrodes 14, which are formed in multiple rings in plan view, are further provided. The curved electrodes 14 are made of a semiconductor of a type different from that of the semiconductor portion 12 and are, for example, made of P type Si doped with a specific dopant such as boron. For example, the curved electrodes 14 are made of p+Si. The multiple curved electrodes 14 are substantially concentric, and the signal output electrode 15 is located approximately at the center of the multiple curved electrodes 14. In other words, the multiple curved electrodes 14 enclose the signal output electrode 15, each of the curved electrodes 14 having a different distance from the signal output electrode 15.

Though FIG. 3 illustrates four curved electrodes 14, more curved electrodes 14 are provided in practice. Note that the curved electrode 14 may be in the form of a ring other than an annular ring, and the multiple curved electrodes 14 are not necessarily concentric with each other. The curved electrodes 14 may be in the form of a ring with a cutaway portion. The signal output electrode 15 may be located at a position other than the center of the multiple curved electrodes 14. The radiation detection element 1 may have multiple sets of signal output electrodes 15, multiple curved electrodes 14 and electrode layers 13.

The innermost curved electrode 14 and the outermost curved electrode 14 are connected to the voltage application unit 33. Voltage is applied from the voltage application unit 33 to the multiple curved electrodes 14 such that the innermost curved electrode 14 has the highest potential and the outermost curved electrode 14 has the lowest potential. In addition, the radiation detection element 1 is configured such that predetermined electrical resistance occurs between the adjacent curved electrodes 14 having different distances from the signal output electrodes 15. For example, by adjusting the components of the part located between adjacent curved electrodes 14, an electrical resistance channel where the two curved electrodes 14 are connected is formed. That is, the multiple curved electrodes 14 are in a continuous connected string via electrical resistance. With the application of voltage, the respective curved electrodes 14 have an electric potential sequentially and monotonously increasing from the outer curved electrode 14 to the inner curved electrode 14. In other words, the electric potential of the curved electrodes 14 sequentially increases from the curved electrode 14 far from the signal output electrode 15 to the curved electrode 14 close the signal output electrode 15. It should be noted that among the multiple curved electrodes 14, a pair of adjacent curved electrodes 14 with the same potential may be included.

The electric potential caused by the multiple curved electrodes 14 generates an electric field (electric potential gradient) where electric potential increases toward the signal output electrode 15 and decreases away from the signal output electrode 15. In addition, the electrode layer 13 is connected to the voltage application unit 33. The voltage application unit 33 applies voltage to the electrode layer 13 such that the electric potential of the electrode layer 13 corresponds to the electric potential between the innermost curved electrode 14 and the outermost curved electrode 14. As such, an electric field where electric potential increases toward the signal output electrode 15 is generated inside the semiconductor portion 12.

The irradiation unit 41 irradiates the sample 6 with X-rays, and fluorescent X-rays generated from the sample 6 enters the radiation detector 2. The radiation formed by fluorescent X-rays passes through mainly the incidence port 221 and enters the inside of the radiation detector 2. Part of the radiation that enters the inside of the radiation detector 2 is shielded by the collimator 24. The radiation not shielded by the collimator 24 enters the radiation detection element 1. The radiation incident to the radiation detection element 1 enters the semiconductor portion 12.

The radiation entering the semiconductor portion 12 is absorbed in the semiconductor portion 12, and electrical charges of the amount corresponding to the energies of the absorbed radiation are generated inside the semiconductor portion 12. The generated electric charges are electrons and holes. The generated electric charges move by the electric field inside the semiconductor portion 12, and one of the types of the electric charges intensively flows into the signal output electrode 15. In the present embodiment, electrons caused by the incidence of radiation move and flow into the signal output electrode 15. The electric charges flowing into the signal output electrode 15 are output as a current signal.

The signal output electrode 15 is connected to the preamplifier 21. The signal output from the signal output electrode 15 is input to the preamplifier 21. The preamplifier 21 converts the current signal into a voltage signal. The preamplifier 21 outputs a signal with an intensity corresponding to the energy of the radiation. The preamplifier 21 is connected to the signal processing unit 34. By outputting the signal from the preamplifier 21, the radiation detector 2 outputs a signal with intensity corresponding to the energy of the radiation. The signal processing unit 34 receives the signal output by the radiation detector 2, and detects the intensity of the signal to detect a signal value corresponding to the energy of the radiation detected by the radiation detector 2. The signal processing unit 34 counts the number of signals for each signal value and outputs data indicating the relationship between the signal values and the numbers of counts to the analysis unit 35.

The analysis unit 35 receives data indicating the relationship between the signal values and the numbers of counts for the signal values that are output by the signal processing unit 34. The analysis unit 35 produces a spectrum of radiation entering the radiation detector 2 based on the data from the signal processing unit 34. The signal values correspond to the energies of radiation, and the numbers of counts for the signal values correspond to the numbers of times radiation is detected, and thus a radiation spectrum is obtained from the relationship between the signal values and the numbers of counts. The spectrum indicates the relationship between the energy and intensity of radiation. Since the radiation entering the radiation detector 2 is fluorescent X-rays generated from the sample 6, the spectrum of the fluorescent X-rays emitted from the sample 6 is obtained.

The processing of counting the signals output by the radiation detector 2 for each signal value may be performed by the analysis unit 35, not by the signal processing unit 34. The spectrum of radiation may be produced by the signal processing unit 34. The analysis unit 35 stores spectrum data representing the spectrum of the fluorescent X-rays. The signal processing unit 34 and the analysis unit 35 correspond to a spectrum production unit. The display unit 36 displays the spectrum of the fluorescent X-rays. This allows the user to check the spectrum of the fluorescent X-rays from the sample 6. The analysis unit 35 may further perform information processing based on the spectrum of the fluorescent X-rays. For example, the analysis unit 35 performs qualitative or quantitative analysis on the element contained in the sample 6 based on the spectrum of the fluorescent X-rays from the sample 6.

The sample 6 irradiated with X-rays by the irradiation unit 41 also generates photoelectrons other than fluorescent X-rays. In the case where photoelectrons enter the radiation detection element 1, a signal caused by the photoelectrons may occur, which causes deterioration of sensitivity to fluorescent X-rays. In the conventional radiation detector where the incidence port is closed by a window material, photoelectrons are shielded by the window material, which hinders the photoelectrons from entering the radiation detection element.

In the present embodiment, fluorescent X-rays passing through the incidence port 221 which is not closed by the window material are detected by the radiation detection element 1. The straight path of fluorescent X-rays from the sample 6 through the incidence port 221 to the radiation detection element 1 is not blocked by an object such as a window material. Since the fluorescent X-rays to be detected do not need to pass through the window material, the radiation detection device 10 can detect the fluorescent X-rays that cannot pass through the window material due to its low energy. This allows the radiation detection device 10 to detect low-energy fluorescent X-rays generated from the sample 6 and analyze the sample 6 based on the low-energy fluorescent X-rays. For example, qualitative or quantitative analysis of light in weight elements contained in the sample 6 may be performed. Meanwhile, photoelectrons can easily pass through the incidence port 221 and enter the radiation detector 2.

As illustrated in FIG. 2, the radiation detector 2 is provided with the magnetic field production part 23. The magnetic field production part 23 produces a magnetic field in at least part of the space from the incidence port 221 to the radiation detection element 1. The photoelectrons generated from the sample 6 enter the radiation detector 2 through the incidence port 221 and move in the space from the incidence port 221 to the radiation detection element 1. Lorentz force is exerted on charged particles moving in the magnetic field. The travel direction of photoelectrons moving in the space from the incidence port 221 to the radiation detection element 1 is bent by the Lorentz force. The photoelectrons whose travel direction is bent collide with the magnetic field production part 23 or the collimator 24. Hence, the travel direction of the photoelectrons is bent on the way to the radiation detection element 1, which hinders the photoelectrons from entering the radiation detection element 1. This prevents photoelectrons from entering the radiation detection element 1, which reduces signals caused by the photoelectrons, preventing the sensitivity to fluorescent X-rays from deteriorating.

The magnets contained in the magnetic field production part 23 are coated with a substance of an element having an atomic number smaller than that of the element contained in the magnets. The multiple magnets are placed on opposite sides of the space from the incidence port 221 to the radiation detection element 1, at least the surfaces facing each other of the magnets being coated. For example, the magnets are neodymium magnets, the surfaces of which are coated with nickel, the nickel is coated with aluminum, and the aluminum is coated with carbon.

When fluorescent X-rays from the sample 6 enters the magnets, other fluorescent X-rays are generated from the magnet. In addition, the photoelectrons whose travel direction is bent collide with the magnets contained in the magnetic field production part 23. Characteristic X-rays are generated from the magnets with which the photoelectrons collide. In the case where the X-rays generated from the magnets enter the radiation detection element 1, the spectrum of the fluorescent X-rays generated from the sample 6 may contain system peaks caused by the X-rays generated from the magnets. Since the surfaces of the magnets are coated, the X-rays generated from the magnets are absorbed in the coating substances for the magnets, which hinders the X-rays from entering the radiation detection element 1. The coating substances for the magnets itself also generate fluorescent X-rays by absorbing the X-rays from the magnets. Since the coating substances for the magnets, however, have smaller atomic numbers, the generated fluorescent X-rays have less energy and lower intensity, resulting in smaller system peaks. The coating thus reduces the system peaks caused by the fluorescent X-rays generated from the magnets.

The interval between the multiple magnets placed on opposite sides of the space from the incidence port 221 to the radiation detection element 1 varies along the direction from the incidence port 221 to the radiation detection element 1. The interval between the multiple magnets is narrower toward the incidence port 221 and wider toward the radiation detection element 1. For example, the multiple magnets are arranged obliquely to each other in such a manner that the interval is wider toward the radiation detection element 1.

In the case where the fluorescent X-rays are directed to the magnets, they do not enter the radiation detection element 1 and are not detected. The fluorescent X-rays generated from the sample 6 radially occurs. In other words, the fluorescent X-rays are wider away from the sample 6 and wider toward the radiation detection element 1. The interval between the multiple magnets is wider toward the radiation detection element 1, and thus even if the fluorescent X-rays spread as they approach the radiation detection element 1, they have a high probability of entering the radiation detection element 1 without entering the magnets. This increases the probability of the fluorescent X-rays being detected. The radiation detection device 10 can thus detect the fluorescent X-rays from the sample 6 with high efficiency. The angle at which the magnets are inclined to each other may be determined depending on the distance from the sample 6 mounted on the sample stage 61 to the radiation detection element 1 so that the fluorescent X-rays can enter the radiation detection element 1 as soon as possible.

As described above, the block 22 is made of a ferromagnetic material. In the case where the block 22 is not made of a ferromagnetic material, the magnetic field produced by the magnetic field production part 23 leaks outside the block 22 and adversely affects the outside of the block 22. In the case where the sample 6 is made of a magnetic material, the sample 6 may be attracted to the magnetic field production part 23 by the magnetic field. The block 22 is made of a ferromagnetic material in the present embodiment, and thus the magnetic field is shielded by the block 22, which can prevent the magnetic field from leaking outside the block 22 and from adversely affecting the outside of the block 22. For example, the sample 6 is not attracted to the block 22, and the magnetic material can be used as the sample 6.

The block 22 has a shape designed to shield the light from the illumination unit 51 so as to hinder direct entrance of the light from the illumination unit 51 to the radiation detection element 1. More specifically, the shape and position of the block 22 are determined so that a part of the block 22 is positioned on the line connecting the incident surface 11 of the radiation detection element 1 and the illumination unit 51 inside the radiation detection device 10. The block 22 is located on the straight path of light from the illumination unit 51 to the radiation detection element 1, and shields the light linearly emitted from the illumination unit 51 to the radiation detection element 1. This prevents light from the illumination unit 51 from entering the radiation detection element 1.

In the case where light from the illumination unit 51 enters the radiation detection element 1, current flows in the radiation detection element 1 in correspondence with the incident light, which increases the current signal output from the radiation detection element 1. The increase in the current signal may cause a malfunction in the radiation detection device 10 such as failure in the preamplifier 21 or deterioration in the detection accuracy of radiation. In the present embodiment, the block 22 prevents light from the illumination unit 51 from entering the radiation detection element 1. This reduces the current caused by the light from the illumination unit 51 flowing in the radiation detection element 1 and prevents a malfunction of the radiation detection device 10 caused by the increase of the current signal from occurring. The malfunction of the radiation detection device 10 is thus suppressed.

Since the block 22 is integrally formed, the housing of the radiation detector 2 has less clearance than that of the conventional radiation detector. This hinders light from the parts other than the incidence port 221 from entering the inside of the radiation detector 2. Light is difficult to enter the inside of the radiation detector 2, which hinders more light from the illumination unit 51 from entering the radiation detection element 1.

In addition, the block 22 and the magnetic field production part 23 have anti-reflective treatment to prevent reflection of illumination light for illuminating the sample 6. For example, the surfaces of the block 22 and the magnetic field production part 23 are colored in black. For example, in the block 22, the surface of the ferromagnetic material is coated with nickel, the nickel is coated with aluminum, and the aluminum is coated with carbon, which blackens the surface of the block 22. The surface of the magnetic field production part 23 is colored in black using carbon. The aluminum surface may be subjected to anti-reflective treatment by being anodized. For example, the surfaces of the block 22 and the magnetic field production part 23 are roughened so as to cause scattering of light. Even if the illumination light from the illumination unit 51 is reflected by the surface of the sample 6 and enters the radiation detector 2, the illumination light is hard to reflect and reach the radiation detection element 1 because anti-reflective treatment is performed on the block 22 and the magnetic field production part 23. This prevents more light from entering the radiation detection element 1.

As described above, entrance of photoelectrons and illumination light to the radiation detection element 1 is suppressed in the present embodiment. Entrance of photoelectrons to the radiation detection element 1 is suppressed, which prevents the sensitivity of the radiation detection device 10 to fluorescent X-rays generated from the sample 6 from deteriorating. In addition, entrance of illumination light into the radiation detection element 1 is suppressed, which prevents the malfunction of the radiation detection device 10 from occurring. The radiation detection device 10 can thus stably detect fluorescent X-rays.

The radiation detection element 1 may be polygonal in plan view. For example, the radiation detection element 1 is rectangular in plan view, and the magnetic field production part 23 has two flat magnets arranged opposing each other. The two magnets are placed in substantially parallel with the long side of the radiation detection element 1 with the space from the incidence port 221 to the radiation detection element 1 interposed therebetween. The arrangement of the two magnets substantially parallel with the long side of the radiation detection element 1 can more reduce the interval between the two magnets without changing the area where radiation enters the radiation detection element 1, as compared to the arrangement of the two magnets substantially parallel with the short side of the radiation detection element 1. The shorter the interval between the two magnets is, the stronger the magnetic field is. Photoelectrons change their travel direction more significantly, and are more difficult to enter the radiation detection element 1. Thus, entrance of photoelectrons into the radiation detection element 1 is suppressed more reliably.

While the present embodiment presents an example where the block 22 and the magnetic field production part 23 are contained in the radiation detector 2, the block 22 and the magnetic field production part 23 may be located outside the radiation detector 2. For example, the radiation detector 2 has a housing without the block 22. The housing has an opening that is not closed by a window material. Fluorescent X-rays that have passed through the opening are detected by the radiation detection element 1. The magnetic field production part 23 is located between the sample 6 and the radiation detector 2, and the block 22 is located in a position where light linearly emitted from the illumination unit 51 to the radiation detection element 1 is shielded. In the present embodiment also, entrance of photoelectrons and illumination light into the radiation detection element 1 is suppressed.

While the present embodiment presents an example where the semiconductor composing the radiation detection element 1 is Si, the radiation detection element 1 may be configured to be composed of a semiconductor other than Si. While the present embodiment presents an example where the semiconductor portion 12 is made of an N type semiconductor, and the electrode layer 13 and the curved electrodes 14 are made of P type semiconductors, the radiation detection element 1 may be configured such that the semiconductor portion 12 is made of a P type semiconductor, and the electrode layer 13 and the curved electrodes 14 are made of N type semiconductors. While the present embodiment presents an example where the radiation detection element 1 is a silicon drift radiation detection element, the radiation detection element 1 may be a semiconductor element other than the silicon drift radiation detection element. For this reason, the radiation detector 2 may be a radiation detector other than the SDD.

While the present embodiment presents an example where the radiation detector 2 is provided with the collimator 24, the radiation detector 2 is not necessarily provided with the collimator 24. While the present embodiment presents an example where the radiation detection device 10 is provided with the X-ray optics 42, the radiation detection device 10 is not necessarily provided with the X-ray optics 42. Alternatively, the radiation detection device 10 may employ the radiation detection element 1 other than a semiconductor element.

The present invention is not limited to the contents of the embodiment described above, and can be modified in various ways to the extent indicated in the claims. In other words, embodiments obtained by combining technical means that have been changed appropriately within the extent indicated in the claim are also included in the technical scope of the present invention.

The matters described in each embodiment can be combined with each other. Moreover, independent claims and dependent claims stated in the scope of claims can be combined with each other in any combination, regardless of the citation format. In addition, the scope of claims uses the form of describing claims that depend from two or more other claims (multi-claim format), though not limited to this form. The scope of claims may also be described using multiple claims that depend from at least one multiple claims (multi-multi claims).

### REFERENCE SIGNS LIST

10 radiation detection device
1 radiation detection element
12 semiconductor portion
2 radiation detector
22 block
221 incidence port
23 magnetic field production part
41 irradiation unit
51 illumination unit
6 sample

1-8. (canceled)

9. A radiation detection device, comprising:
an illumination unit illuminating a sample;
an irradiation unit irradiating the sample with X-rays;
a radiation detection element detecting X-rays generated from the sample;
a magnetic field production unit that produces a magnetic field in part of a space from the sample to the radiation detection element; and
a block that holds the magnetic field production unit, wherein
the block is located so as to shield light from the illumination unit to the radiation detection element.

10. The radiation detection device according to claim 9, wherein
the magnetic field production unit and the block are subjected to anti-reflective treatment.

11. The radiation detection device according to claim 9, wherein
the magnetic field production unit includes a magnet, and
the magnet is coated with a substance of an element with an atomic number smaller than an atomic number of an element contained in the magnet.

12. The radiation detection device according to claim 9, wherein
the magnetic field production unit includes a plurality of magnets opposing each other with part of a space from the sample to the radiation detection element interposed between the magnets, and
an interval between the plurality of magnets varies in a direction from the sample to the radiation detection element, the interval being wider toward the radiation detection element.

13. The radiation detection device according to claim 9, wherein
the block has an internal space,
the magnetic field production unit is located inside the block, and
the block is made of a ferromagnetic material.

14. The radiation detection device according to claim 9, wherein
a straight path from the sample to the radiation detection element is not blocked.

15. The radiation detection device according to claim 9, further comprising:
a spectrum production unit that produces a spectrum of radiation detected using the radiation detection element; and
a display unit that displays the spectrum produced by the spectrum production unit.

16. A radiation detector for detecting fluorescent X-rays, comprising:
a block having an internal space;
an incidence port formed on the block and through which the fluorescent X-rays enter;
a radiation detection element facing the incidence port; and
a magnetic field production unit that is located inside the block and produces a magnetic field in a space from the incidence port to the radiation detection element, wherein
the incidence port is not closed, and a straight path from the incidence port to the radiation detection element is not blocked.
